(19) United States
(12) Patent Application Publication
(10) Pub. No.: US 2014/0092497 A1
(43) Pub. Date: Apr. 3, 2014

(54) Color Filter and Related Manufacturing Method Thereof

(71) Applicant: SHENZHEN CHINA STAR OPTOELECTRONICS TECHNOLOGY CO., LTD., Shenzhen, Guangdong (CN)

(72) Inventor: Jiwang Yuan, Shenzhen (CN)

(73) Assignee: SHENZHEN CHINA STAR OPTOELECTRONICS TECHNOLOGY CO., LTD, Shenzhen, Guangdong (CN)

(21) Appl. No.: 13/696,066

(22) PCT Filed: Oct. 10, 2012
(86) PCT No.: PCT/CN2012/082829

§ 371 Date: Nov. 2, 2012

(30) Foreign Application Priority Data
Sep. 29, 2012 (CN) 201210371457.4

(51) Int. Cl. G02B 5/20

(52) U.S. Cl. CPC G02B 5/201
USPC 359/891; 216/24

(57) ABSTRACT

The present invention discloses a manufacturing method for manufacturing a color filter. The manufacturing method includes: providing a glass substrate; forming a black matrix layer on the glass substrate; depositing a color film layer on the glass substrate and the back matrix layer; utilizing a mask having a plurality of regions having different levels of light transmittance to expose the color film layer in different degrees; and etching the color film layer according to the exposing result to partially etch a first region of the color film layer and completely etch a second region of the color film layer. The color film layer overlaps the back matrix in the first region and the second region.

### BACKGROUND OF THE INVENTION

1. Field of the Invention

The invention relates to an LCD, and more particularly, to a color filter and related manufacturing method thereof.

2. Description of the Prior Art

Liquid crystal display (LCD) has been widely used in modern information processing equipments such as computers, mobile phones, personal digital assistances (PDA) because of its advantages of light, thin, low power consumption. Generally speaking, the LCD comprises an LCD panel and backlight module. Because the LCD is not self-lighting, the LCD needs the light source inside the backlight module to generate light. The light pass through the liquid crystals of the LCD to adjust the luminance according to the rotation of the liquid crystals such that an image can be output to users.

The color filter is a necessary component of the LCD. In general, the color filter is placed in front of the light source. The light are separated by the color filter into red light, blue light, and green light. In this way, the image can be shown by LCD.

Please refer to FIG. 1, which is a diagram showing the structure of a conventional color filter 100. The color filter 100 comprises a glass substrate 110, a black matrix layer 120, a red film layer 131, a green film layer 132, and a blue film layer 133. The red film layer 131, the green film layer 132, and a blue film layer 133 are called as a color film layer. The LCD separates the white light into red light, blue light, and green light by these color film layers such that a colorful image can be displayed.

From FIG. 1, it can be seen that the red film layer 131, the green film layer 132, and a blue film layer 133 overlaps the black matrix layer 120 in overlapping regions. The overlapping regions are used to prevent the light from emitting from the edge of each color film layer. However, these overlapping regions are not well handled by the etching process. This makes the height of the overlapping regions of the color film layer and the black matrix layer 120 is higher than the non-overlapping regions. In other words, the overlapping regions seem like bulges, which form a height difference “d” between the overlapping regions and the non-overlapping regions. The height difference d may ruin the arrangement of liquid crystals on the edges of the sub-pixel.

Therefore, a solution is needed to solve the above-mentioned problem.

### SUMMARY OF THE INVENTION

It is therefore one of the primary objectives of the claimed invention to provide an color filter and related manufacturing method, which utilizes a mask having a plurality of regions having different levels of light-transmittance to manufacture the color film layer. In this way, in the following etching process, different regions of the color film layer are etched in different degrees in order to make the height of the overlapping region of the color film layer and the black matrix layer substantially equal to the height of the non-overlapping region. In this way, the problem caused by the conventional height difference can be removed, and the arrangement of liquid crystals on the edges of sub-pixels can thus be better.

According to the present invention, a manufacturing method for manufacturing a color filter comprises: providing a glass substrate; forming a black matrix layer on the glass substrate; depositing a color film layer on the glass substrate and the back matrix layer; utilizing a mask having a plurality of regions having different levels of light-transmittance to expose the color film layer in different degrees; and etching the color film layer according to the exposing result to partially etch a first region of the color film layer and completely etch a second region of the color film layer. The color film layer overlaps the back matrix in the first region and the second region.

In one aspect of the present invention, the mask is a half-tone mask.

In another aspect of the present invention, the color film layer comprises a red film layer, and the step of generating the red film layer comprises: generating the red film layer on the substrate and the black matrix layer; utilizing the mask to expose the red film in different degrees; and etching the red film layer according to exposing result.

In another aspect of the present invention, the color film layer comprises a red color filter, a green color filter, and blue color filter.

According to the present invention, a color filter comprises: a glass substrate; a black matrix layer, placed on the glass substrate; a color film layer, placed on the glass substrate and the black matrix layer. An overlapping region and a non-overlapping region of the black matrix and the color film layer have substantially the same height.

In one aspect of the present invention, the same height of the overlapping region and non-overlapping region of the black matrix and the color film layer is accomplished by utilizing a mask having the plurality of regions having different levels of light-transmittance to expose the color film layer and etching the color film layer according to the exposing result.

In another aspect of the present invention, the mask is a half-tone mask.

In another aspect of the present invention, the color film layer comprises a red color filter, a green color filter, and blue color filter.

The present invention provides a color filter and related manufacturing method, which utilizes a mask having a plurality of regions having different levels of light-transmittance to manufacture the color film layer. Therefore, the color film layer is exposed in different degrees. In this way, in the following etching process, different regions of the color film layer having different exposing results are etched in different degrees. This allows the height of the overlapping region of the color film layer and the black matrix layer substantially equal to the height of the non-overlapping region of the color film layer and the black matrix layer. Therefore, the present invention can remove the problem caused by the height difference, and improve the arrangement of the liquid crystals on the edges of sub-pixels.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a conventional color filter.

FIG. 2 is a diagram showing a color filter according to a preferred embodiment of the present invention.

FIG. 3 to FIG. 9 show manufacturing processes of the color filter shown in FIG. 2.

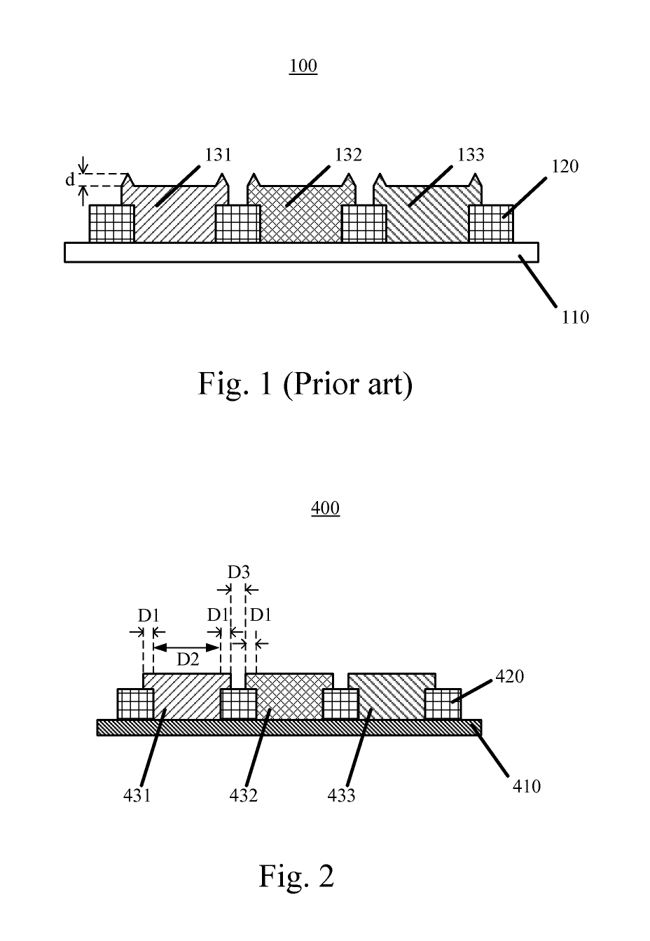

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Please refer to FIG. 2, which is a diagram showing a color filter 400 according to a preferred embodiment of the present invention. The color filter 400 comprises a glass substrate 410, a black matrix layer 420, a red film layer 431, a blue film layer 432, and a green film layer 433. The red film layer 431, the blue film layer 432, and a green film layer 433 are called as a color film layer. The LCD separates the white light into red light, blue light, and green light by these color film layers such that a colorful image can be displayed.

Please note, in this embodiment, the height difference of the color film layer no longer exist. Taking the red film 431 as an example, the overlapping region D1 of the red film layer 431 and the black matrix layer 420 has substantially the same height of the non-overlapping region D2. This is achieved by utilizing the present invention manufacturing process, and the manufacturing process will be illustrated in the following disclosure.

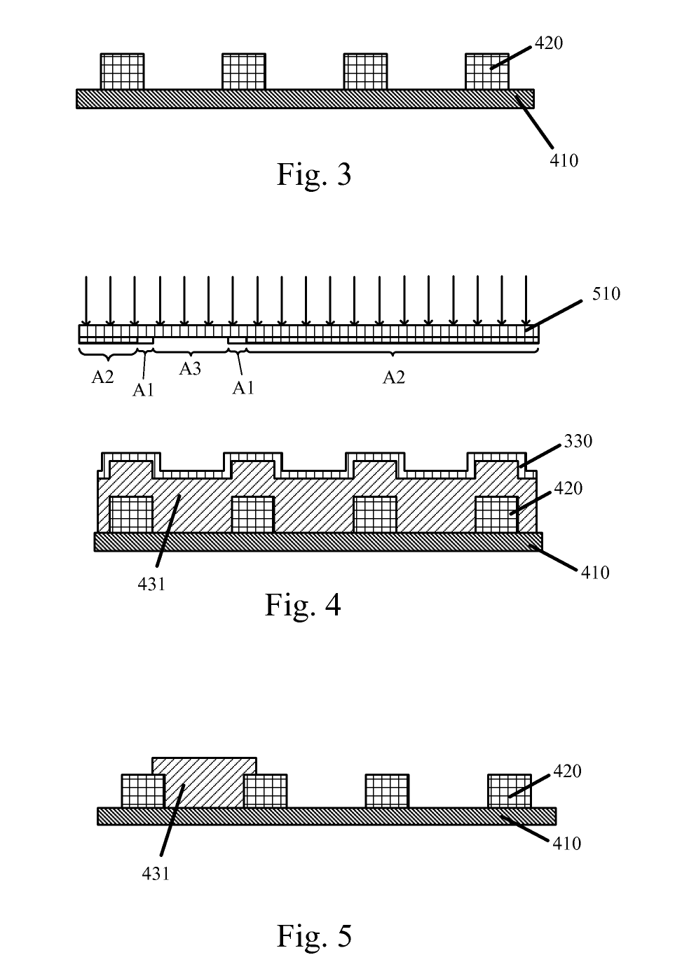

Please refer to FIG. 3 to FIG. 9. FIG. 3 to FIG. 9 show the manufacturing process of the color filter 400 shown in FIG. 2. Please refer to FIG. 3 first. A color-resistance layer is formed on the glass substrate 410. And then, the color-resistance layer is exposed and etched to form the black matrix layer 420.

Please refer to FIG. 4. The red film layer 431 is deposited on the glass substrate 410 and the black matrix layer 420. And then, a half-tone mask 510 is utilized to expose the red film 431. The half-tone mask 510 has a plurality of regions having different levels of light-transmittance. For example, the half-tone mask 510 has three regions A1, A2, and A3. The region Al represents a region that part of light can pass through. The region A2 represents a region that light is absorbed. The region A3 represents a region that light can completely pass through. Therefore, the present invention can properly utilize the half-tone mask to expose the red film layer 431. For example, the region Al of the half-tone mask 510 can align with the region, which is going to be partially removed, of the red film layer 431 (such as the region D1 shown in FIG. 2). The region A2 of the half-tone mask 510 can align with the region, which is going to be completely removed, of the red film layer 431 (such as the region D3 shown in FIG. 2). The region A3 of the half-tone mask 510 can align with the region, which is going to be retained, of the red film layer 431 (such as the region D2 shown in FIG. 2). Because the regions A1, A2, and A3 of half-tone mask 510 have different levels of light-transmittance, the photoresist 330 is exposed with different exposures according to the levels of light-transmittance of the half-tone mask 510. After that, a chemical solution is used to remove partial red film layer 431 corresponding to the first region A1 and to remove all red film layer 431 corresponding to the second region A2. The red film layer 431 corresponding to the third region A3 is retained due to the protection of the photoresist. At last, another chemical solution is used to remove the photoresist.

Please refer to FIG. 5. Because the exposure process has been performed in different degrees, the etching process is performed according to the exposing result. That is, the red film 431 corresponding to the first region D1, that is a bulge-like region, is partially etched, the red film 431 corresponding to the region D2 are completely retained, and the red film layer 431 corresponding to the third region D3 is completely etched. In this way, the red film layer 431 can have no height difference through appropriate height difference.

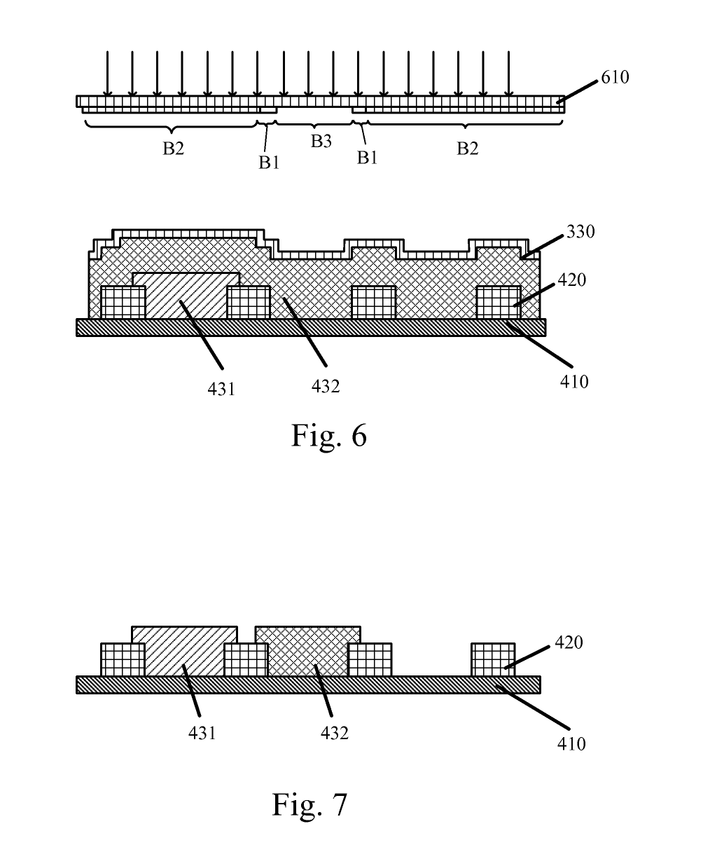

Please refer to FIG. 6. The blue film layer 432 is deposited on the glass substrate 410 and the black matrix layer 420, and the photoresist 330 is spread on the blue film layer 432. And then, the half-tone mask 610 is utilized to expose the blue film layer 432. The half-tone mask 610 has a plurality of regions having different levels of light transmittance. For example, the half-tone mask 610 has three regions B1, B2, and B3. The region B1 represents a region that part of light can pass through. The region B2 represents a region that light is absorbed. The region B3 represents a region that light can completely pass through. Therefore, the present invention can properly utilize the half-tone mask 610 to expose the blue film layer 432. For example, the region B1 of the half-tone mask 610 can align with the region, which is going to be partially removed, of the blue film layer 432. The region B2 of the half-tone mask 610 can align with the region, which is going to be completely removed, of the blue film layer 432. The region B3 of the half-tone mask 610 can align with the region, which is going to be retained, of the blue film layer 432. Because the regions B1, B2, and B3 of half-tone mask 610 have different levels of light transmittance, the photoresist 330 is exposed with different exposures according to the levels of light transmittance of the half-tone mask 610. After that, a chemical solution is used to remove partial blue film layer 432 corresponding to the first region B1 and to remove all blue film layer 432 corresponding to the second region A2. The blue film layer 432 corresponding to the third region B3 is retained due to the protection of the photoresist. At last, another chemical solution is used to remove the photoresist.

Please refer to FIG. 7. Because the exposure process has been performed in different degrees, the etching process is performed according to the exposing result. That is, the blue film layer 432 corresponding to the first region B1, that is a bulge-like region, is partially etched, the blue film layer 432 corresponding to the region B2 are completely retained, and the blue film layer 432 corresponding to the third region B3 is completely etched. In this way, the blue film layer 432 can have no height difference through appropriate height difference.

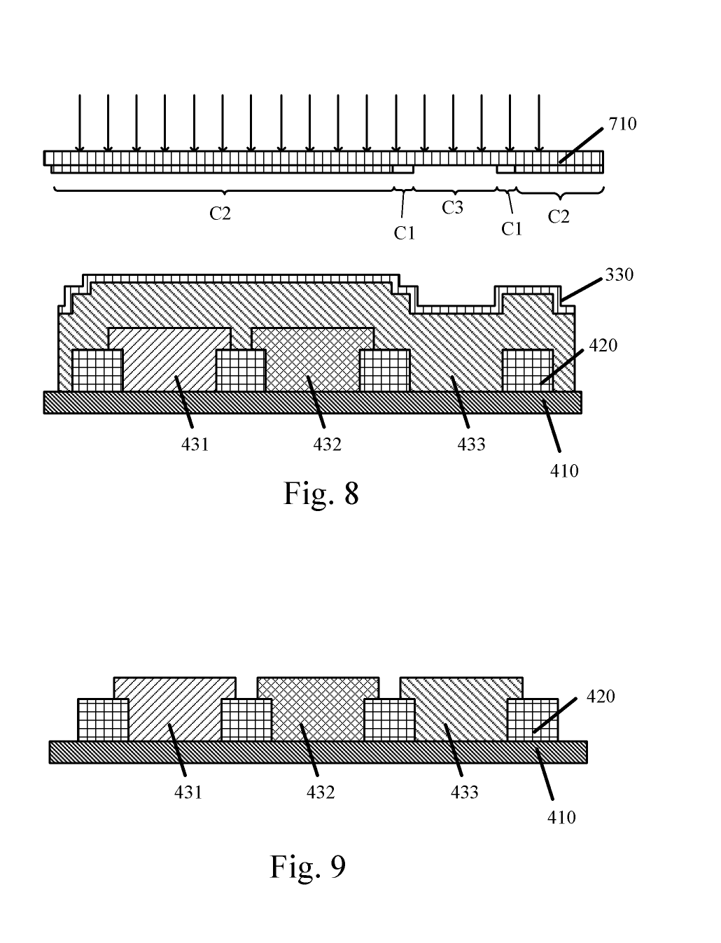

Please refer to FIG. 8. The green film layer 433 is deposited on the glass substrate 410 and the black matrix layer 420, and the photoresist 330 is spread on the green film layer 433. And then, the half-tone mask 710 is utilized to expose the green film layer 433. The half-tone mask 710 has a plurality of regions having different levels of light transmittance. For example, the half-tone mask 710 has three regions C1, C2, and C3. The region C1 represents a region that part of light can pass through. The region C2 represents a region that light cannot pass through. The region C3 represents a region that light can completely pass through. Therefore, the present invention can properly utilize the half-tone mask 710 to expose the green film layer 433. For example, the region C1 of the half-tone mask 710 can align with the region, which is going to be partially removed, of the green film layer 433. The region C2 of the half-tone mask 710 can align with the region, which is going to be completely removed, of the green film layer 433. The region C3 of the half-tone mask 710 can align with the region, which is going to be retained, of the green film layer 433. Because the regions C1, C2, and C3 of half-tone mask 710 have different levels of light transmittance, the photoresist 330 is exposed with different exposures according to the levels of light transmittance of the half-tone mask 710. After that, a chemical solution is used to remove partial green film layer 433 corresponding to the first region C1 and to remove all green film layer 433 corresponding to the second region C2. The green film layer 433 corresponding to the third region C3 is retained due to the protection of the photoresist. At last, another chemical solution is used to remove the photoresist.

Please refer to FIG. 9. Because the exposure process has been performed in different degrees, the etching process is performed according to the exposing result. That is, the green film layer 433 corresponding to the first region C1, that is a bulge-like region, is partially etched, the green film layer 433 corresponding to the region C2 are completely retained, and the green film layer 433 corresponding to the third region C3 is completely etched. In this way, the green film layer 433 can have no height difference through appropriate height difference.

From the above, it can be seen that the color filter 400 is completely manufactured.

Please note, the manufacturing processes of color film layer are not limited. The color film can be manufactured through printing, depositing, or any other manufacturing processes. These disclosures also obey the spirit of the present invention.

In contrast to the related art, the present invention provides a color filter and related manufacturing method, which utilizes a mask having a plurality of regions having levels of light transmittance to manufacture the color film layer. Therefore, the color film layer is exposed in different degrees. In this way, in the following etching process, different regions of the color film layer having different exposing results are etched in different degrees. This allows the height of the overlapping region of the color film layer and the black matrix layer substantially equal to the height of the non-overlapping region of the color film layer and the black matrix layer. Therefore, the present invention can remove the problem caused by the height difference, and improve the arrangement of the liquid crystals on the edges of sub-pixels.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A manufacturing method for manufacturing a color filter, comprising:
providing a glass substrate;
forming a black matrix layer on the glass substrate;
depositing a color film layer on the glass substrate and the back matrix layer;
utilizing a mask having a plurality of regions having different levels of light transmittance to expose the color film layer in different degrees; and
etching the color film layer according to an exposing result to partially etch a first region of the color film layer and completely etch a second region of the color film layer;
wherein the color film layer overlaps the back matrix in the first region and the second region.

2. The manufacturing method of claim 1, wherein the mask is a half-tone mask.

3. The manufacturing method of claim 2, wherein the color film layer comprises a red film layer, and the step of generating the red film layer comprises:
generating the red film layer on the substrate and the black matrix layer;
utilizing the mask to expose the red film in different degrees; and
etching the red film layer according to exposing result.

4. The manufacturing method of claim 2, wherein the color film layer comprises a red color filter, a green color filter, and blue color filter.

5. A color filter comprising:
a glass substrate;
a black matrix layer, placed on the glass substrate;
a color film layer, placed on the glass substrate and the black matrix layer;
wherein an overlapping region and a non-overlapping region of the black matrix and the color film layer have substantially the same height.

6. The color filter of claim 5, wherein the same height of the overlapping region and non-overlapping region of the black matrix and the color film layer is accomplished by utilizing a mask having a plurality of regions having different levels of light transmittance to expose the color film layer and etching the color film layer according to exposing result.

7. The color filter of claim 6, wherein the mask is a half-tone mask.

8. The color filter of claim 5, wherein the color film layer comprises a red color filter, a green color filter, and blue color filter.
